(19) United States
(12) Patent Application Publication
(10) Pub. No.: US 2016/0001541 A1
(43) Pub. Date: Jan. 7, 2016

(54) Preparation of Multilayer Structural Composites Prepared Using Consolidation Liners Of High Parting Force

(71) Applicant: WACKER CHEMICAL CORPORATION, Adrian, MI (US)

(72) Inventors: Timothy RUMMEL, Saline, MI (US); Kathleen BEEKEL, Adrian, MI (US)

(21) Appl. No.: 14/322,949

(22) Filed: Jul. 3, 2014

(51) Int. Cl. B32B 37/26; C09D 183/06; C08J 5/24; C09D 123/08; B32B 37/16; B32B 38/00

(52) U.S. Cl. CPC B32B 37/26; B32B 37/16; B32B 38/00; C08J 5/24; C09D 123/0853; C09D 183/06; B32B 2037/268; B32B 2038/0076; B32B 2260/046; B32B 2305/076; B32B 2305/77; B32B 2307/748; C08J 2363/00

(57) ABSTRACT

Composite structures prepared by laying up a plurality of plies of thermoplastic or thermoset fiber reinforced prepregs are produced by adhering a high parting force consolidation liner on at least one surface of the layup prior to curing and consolidation. The surface coating on the release paper is preferably free of controlled release additives, adheres well to consolidated compositions, and can be removed to expose the composite surface.

### BACKGROUND OF THE INVENTION

1. Field of the Invention

The invention relates to a process for the preparation of structural composites from fiber reinforced prepregs, where consolidation of the prepregs into a multi-layer composite is facilitated by a consolidation liner having a high parting force, which preferably contains no controlled release additives.

2. Description of the Related Art

Fiber reinforced composite structures prepared from fiber reinforced prepregs have been important in many industrial sectors, particularly in the aerospace industry. In commercial aircraft, for example, fiber reinforced composites are increasingly being used for non-critical sections of aircraft. However, in military aircraft such as attack helicopters, jet fighters and bombers (including stealth versions), fiber reinforced composites, particularly those using carbon fiber reinforcement, are used in critical components such as stressed body panels, wings, tail sections, ailerons, etc. Prepregs have also been used to manufacture blades of helicopters, and wind turbines as well.

Such products are generally prepared in quasi-isotropic layups, where “prepregs” containing a high strength thermoplastic polymer resin such as a polyetherketone, polyether sulfone, polyimide, or their variants, or a B-staged curable thermosetting resin such as epoxy, bismaleimide, cyanate, or crosslinkable polyimide, and also containing generally unidirectional fibers are used. Fibers may, for example, be glass fibers, carbon fibers, UHMWPE fibers, aramid fibers and the like. Prepregs may also be based on woven of non-woven cloth of such fibers, or combinations of these. The prepregs are “laid up” with the desired fiber orientations and number of plies.

Once the desired, unconsolidated prepreg “lay-up” has been assembled, it must then be consolidated. Consolidation takes place at high temperature and generally under high pressure, the temperature used depending principally upon the curing profile of the thermoset resin, when such resins are used, or the melt temperature and melt flow rate when thermoplastic resins are used. The pressure must be high enough to guarantee complete contact between the many layers, and to eliminate voids. Some composite lay-ups are evacuated prior to cure, to eliminate the risk of trapping air bubbles, and then introduced into a high pressure autoclave, or a press or mold. Many parts are encased in “vacuum bags” for this purpose. In the present invention, high pressure is a pressure higher than 0.25 kPa, more preferably higher than 0.5 kPa, and most preferably about 1 kPa to 15 kPa.

During cure, it is often necessary that a consolidation liner be adhered to the uncured lay-up, to prevent the structure from becoming bonded to the autoclave, or to the mold in which it is cured. The consolidation liner may also aid in retaining resin whose viscosity has been lowered as the temperature is increased to the consolidation temperature, but is still of low enough viscosity to flow or drip. Finally, the consolidation liner may add in development of a smooth and, where necessary, a textured or aesthetic surface. Release papers may be used to provide stiffness and handleability to the uncured prepregs during the laying up of the uncured composite structure. These release papers have characteristics quite different from consolidation liners.

Silicone coated release papers have long been used in many fields where release from tacky substances is needed. Such papers offer low release force and may be useful in lining the prepregs prior to lay-up, during lay-up, and for improved shipping and handling characteristics. However, while prepregs such as thermoset resin prepregs can be quite tacky, the consolidated structure is not tacky at all, and release papers may separate prematurely from the consolidated composite. Solvent and emulsion tin condensation-curing systems, and solvent free and organic solvent-borne addition curing systems can achieve a high enough release level to satisfy many composites applications. Each of these systems also exhibit noted disadvantages, including in some cases, slow rates of cure, and in others, the use of organic solvents, which is highly disfavored. Furthermore, yet higher parting force than can be provided by such systems is often desirable.

It would be desirable to provide a process for structural composite manufacture where a consolidation liner is used, whose parting surface can be prepared economically and substantially solvent free, has a high cure rate, and which has a high parting force even on cured parts. Addition curable organopolysiloxane coatings would appear to be good candidates, as they exhibit high rates of cure, and can be coated without the use of appreciable amounts of solvent, or of any solvent. However, their parting force is too low. In the past, “controlled release additives” have been added to addition curable and other silicone release coatings to increase parting force. However, the increase in parting force is often not high enough. It would further be desirable to employ a consolidation liner or release paper in prepreg and composite applications where the release force can be widely adjusted, and which can exhibit higher release force than silicone compositions employing controlled release additives.

### SUMMARY

It has now been surprisingly and unexpectedly discovered that in the consolidation of composite structures by lay-up of fiber reinforced prepregs and subsequent cure into a consolidated, fiber-reinforced composite structure, satisfactorily high and consistent parting force of a consolidation liner is achieved by a substrate, e.g. paper, coated with a combination of an aqueous emulsion of a vinyl addition polymer, an ethylenically unsaturated organopolysiloxane, an Si—H functional silane or polysiloxane, and a hydrosilylation catalyst. The presence of a controlled release additive is not necessary, and not preferred. The compositions are preferably free of controlled release additives.

### DETAILED DESCRIPTION OF THE PREFERRED EMBODIMENTS

The fiber reinforced prepregs useful in the present invention include all those prepregs having fiber reinforcement and a curable thermoset and/or fusible thermoplastic matrix. Such prepregs are well known and are now staple items of commerce. The fibers may be continuous or discontinuous, and may be in the form of individual fibers, multi-fiber strands of fibers, tow, yarn, woven or non-woven fabric or the like.

Suitable thermosetting resins include, for example, but not by limitation, epoxy resins, cyanate reins, bismaleimide resins, and crosslinkable polyimide resins. These resins may also contain particulate thermoplastics to improve delamination strength. The resins are generally B-staged in the prepregs. Suitable thermoplastic resins include polyamides, polycarbonates, polyarylsulfides, polyarylsulfones, polyether sulfones, polyether ketones (“PEK”) and their analogues such as PEKK, PEKEK, etc. All these are well known in the art.

The consolidation liner used in the inventive process comprises a substrate coated with a parting coating. Paper, for example, Kraft process paper, preferably calendered, is preferred, but other commonly used substrates such as polymer films, paper/polymer film laminates, metal foils, woven and non-woven scrim, and combinations thereof may also be used. The consolidation liner does not constitute part of the finished composite structure, but is parted therefrom following cure. In this application, “cure” implies a final consolidation, e.g. crosslinking of a thermoset resin, particularly a B-staged thermoset resin to a fully crosslinked state, as well as consolidation of thermoplastic matrix prepregs by fusion of the polymer, where no or little crosslinking takes place.

The parting composition is an aqueous, curable composition containing from 0.5 to 80 weight percent, preferably 3 to 30 weight percent, and most preferably 4 to 12 weight percent, all weight percents based on solids, of an emulsion or suspension polymerized addition polymer (A), in the form of an aqueous dispersion; a polyorganosiloxane (B) bearing at least two ethylenically unsaturated Si—C bonded hydrocarbon groups; an Si—H functional silane or siloxane (C) bearing at least three silicon-bonded hydrogen atoms; and a hydrosilylation catalyst (D). More than one of each type of component may be used.

The suspension or preferably emulsion polymerized addition polymer or copolymer (A) may have a wide range of molecular weights and Tg. The Tg may be, for example, from −75° C. to +100° C. The polymers are prepared by suspension or emulsion polymerization of an aqueous dispersion of vinyl monomers, with gaseous monomers such as ethylene, propylene, or 1,3-butadiene, for example, being supplied under pressure. One or more emulsifiers are added to keep the vinyl monomers and growing polymers in the form of an emulsion and/or dispersion. The polymerization temperature is generally from 40 to 100° C., preferably from 60 to 80° C. In the case of the copolymerization of gaseous comonomers, operation may be carried out at superatmospheric pressure, generally at from 5 to 100 bar. Such polymer dispersions are well established items of commerce.

The emulsion polymerized addition polymers are preferably based on homo- or copolymers of one or more monomers from the group of vinyl esters of unbranched or branched alkyl carboxylic acids having from 1 to 15 carbon atoms, methacrylic esters and acrylic esters of alcohols having from 1 to 15 carbon atoms, vinylaromatics, olefins, dienes, and vinyl halides.

Vinyl esters suitable for the base polymer are those of carboxylic acids having from 1 to 15 carbon atoms. Preferred vinyl esters are vinyl acetate, vinyl propionate, vinyl butyrate, vinyl-2-ethylhexanoate, vinyl laurate, 1-methylvinyl acetate, vinyl pivalate and vinyl esters of α-branched monocarboxylic acids having from 9 to 13 carbon atoms, examples being VeoVa9® or VeoVa10®, available from Momentive. Vinyl acetate is particularly preferred.

Suitable methacrylic esters or acrylic esters (“(meth)acrylic esters”) are esters of unbranched or branched (“optionally branched”) alcohols having from 1 to 15 carbon atoms, examples being methyl acrylate, methyl methacrylate, ethyl acrylate, ethyl methacrylate, propyl acrylate, propyl methacrylate, n-butyl acrylate, n-butyl methacrylate, 2-ethylhexyl acrylate, and norbornyl acrylate. Preference is given to methyl acrylate, methyl methacrylate, n-butyl acrylate and 2-ethylhexyl acrylate.

Examples of olefins and dienes are ethylene, propylene and 1,3-butadiene. Suitable vinylaromatics are styrene and vinyltoluene. A suitable vinyl halide is vinyl chloride.

Where appropriate, from 0.05 to 50% by weight, preferably from 1 to 10% by weight, based on the total weight of the base polymer, of auxiliary monomers may also be copolymerized. Examples of auxiliary monomers are ethylenically unsaturated mono- and dicarboxylic acids, preferably acrylic acid, methacrylic acid, fumaric acid, and maleic acid; ethylenically unsaturated carboxamides and carbonitriles, preferably acrylamide and acrylonitrile; mono- and diesters of fumaric acid and maleic acid, for example the diethyl and diisopropyl esters; and also maleic anhydride, and ethylenically unsaturated sulfonic acids and their salts, preferably vinyl sulfonic acid and 2-acrylamido-2-methyl-propanesulfonic acid. Other examples are pre-crosslinking comonomers, for example ethylenically polyunsaturated comonomers such as divinyl adipate, diallyl maleate, allyl methacrylate, or triallyl cyanurate, or post-crosslinking comonomers, such as acrylamidoglycolic acid (AGA), methyl methacrylamidoglycolate (MAGME), N-methylol acrylamide (NMA), N-methylolmethacrylamide (NMMA), allyl N-methylol carbamate, alkyl ethers or esters of N-methylolacrylamide, of N-methylolmethacrylamide, or of allyl N-methylolcarbamate, such as their isobutoxy ethers. Epoxy-functional comonomers, such as glycidyl methacrylate and glycidyl acrylate, are also suitable.

Other examples are silicon-functional comonomers, such as acryloxypropyltri(alkoxy)- and methacryloxypropyltri(alkoxy)silanes, vinyl trialkoxysilanes, and vinyl methyldialkoxysilanes, examples of alkoxy groups which may be present being methoxy, ethoxy, and ethoxypropylene glycol ether radicals. Use of silicon-functional comonomers is not preferred. Mention may also be made of monomers having hydroxy or CO groups, e.g. hydroxyalkyl esters of methacrylic acid or of acrylic acid, e.g. hydroxyethyl, hydroxypropyl, or hydroxybutyl acrylate or methacrylate, and also of compounds such as diacetoneacrylamide and acetylacetoxyethyl acrylate or methacrylate.

Examples of suitable homo- and copolymers are vinyl acetate homopolymers; copolymers of vinyl acetate with ethylene; copolymers of vinyl acetate with ethylene and with one or more other vinyl esters; copolymers of vinyl acetate with ethylene and acrylic esters, copolymers of vinyl acetate with ethylene and vinyl chloride; styrene-acrylic ester copolymers; and styrene-1,3-butadiene copolymers.

Preference is given to vinyl acetate homopolymers; copolymers of vinyl acetate with from 1 to 40% by weight of ethylene; copolymers of vinyl acetate with from 1 to 40% by weight of ethylene and from 1 to 50% by weight of one or more other comonomers from the group of vinyl esters having from 1 to 12 carbon atoms in the carboxylic acid radical, e.g. vinyl propionate, vinyl laurate, vinyl esters of alpha-branched carboxylic acids having from 9 to 13 carbon atoms such as VeoVa9, VeoVa10, and VeoVa11; copolymers of vinyl acetate, from 1 to 40% by weight of ethylene, and preferably from 1 to 60% by weight of acrylic ester(s) of unbranched or branched alcohols having from 1 to 15 carbon atoms, in particular N-butyl acrylate or 2-ethylhexyl acrylate; and copolymers using from 30 to 75% by weight of vinyl acetate, from 1 to 30% by weight of vinyl laurate or vinyl esters of an alpha-branched carboxylic acid having from 9 to 11 carbon atoms, and also from 1 to 30% by weight of acrylic esters of unbranched or branched alcohols having from 1 to 15 carbon atoms, in particular n-butyl acrylate or 2-ethyl hexyl acrylate, where these also contain from 1 to 40% by weight of ethylene; and copolymers using vinyl acetate, from 1 to 40% by weight of ethylene, and from 1 to 60% by weight of vinyl chloride; where the polymers may also contain the amounts mentioned of the auxiliary monomers mentioned, the percentage by weight in each case totaling 100% by weight. A preferred ethylene/vinyl acetate polymer is VINNAPAS® 315, available from Wacker Chemie AG, Munich, Germany.

Preference is also given to copolymers of n-butyl acrylate or 2-ethylhexyl acrylate, or copolymers of methyl methacrylate with n-butyl acrylate and/or 2-ethylhexyl acrylate; styrene-acrylic ester copolymers using one or more monomers from among methyl acrylate, ethyl acrylate, propyl acrylate, n-butyl acrylate, and 2-ethylhexyl acrylate; vinyl acetate-acrylic ester copolymers using one or more monomers from the group of methyl acrylate, ethyl acrylate, propyl acrylate, n-butyl acrylate, 2-ethylhexyl acrylate, and, where appropriate, ethylene; and styrene-1,3-butadiene copolymers; where the polymers may also contain auxiliary monomers, and the percentages by weight totals 100%.

The selection of monomer or the selection of the parts by weight of the comonomers is preferably such that the resultant glass transition temperature Tg is from −75° C. to 100° C., more preferably from −30° C. to +40° C. The glass transition temperature Tg of the polymers may be determined in a known manner by differential scanning calorimetry (DSC). The Fox equation may also be used for an approximate preliminary calculation of Tg. According to T. G. Fox, BULL. AM. PHYSICS SOC. 1, 3, page 123 (1956): 1/Tg=x₁/Tg₁+x₂/Tg₂+ . . . +xₙ/Tgₙ, where xₙ is the fraction by weight (% by weight/100) of the monomer n, and Tgₙ is the glass transition temperature in Kelvin of the homopolymer of the monomer n. Tg values for homopolymers are listed in POLYMER HANDBOOK 2nd Edition, J. Wiley & Sons, New York (1975).

The polymerization is initiated using water-soluble or monomer-soluble initiators or redox-initiator combinations, these being those commonly used for emulsion polymerization and suspension polymerization, respectively. Examples of water-soluble initiators are the sodium, potassium, and ammonium salts of peroxydisulfuric acid, hydrogen peroxide, tert-butyl peroxide, tert-butyl hydroperoxide, potassium peroxydiphosphate, tert-butyl peroxypivalate, cumene hydroperoxide, isopropylbenzene monohydroperoxide, and azobisisobutyronitrile. Examples of monomer-soluble initiators are dicetyl peroxydicarbonate, dicyclohexyl peroxydicarbonate, and dibenzoyl peroxide. The amount of the initiators generally used is from 0.01 to 0.5% by weight, based on the total weight of the monomers.

Redox initiators include combinations of the initiators previously mentioned with reducing agents. Suitable reducing agents are the sulfites and bisulfites of the alkali metals and of ammonium, for example sodium sulfite, the derivatives of sulfoxylic acid, for example zinc formaldehyde sulfoxylates or alkali metal formaldehyde sulfoxylates, an example being sodium hydroxymethanesulfinate, and ascorbic acid. The amount of reducing agent is preferably from 0.01 to 0.5% by weight, based on the total weight of the monomers.

To control molecular weight, molecular weight regulating substances (chain transfer agents) may be used during the polymerization process. If regulators are used, the amounts are generally from 0.01 to 5.0% by weight, based on the weight of the monomers to be polymerized, and the regulators may be fed separately and/or after premixing with other components for the reaction. Examples of these substances are n-dodecyl mercaptan, tert-dodecyl mercaptan, mercaptopropionic acid, methyl mercaptopropionate, isopropanol, and acetaldehyde. It is preferable not to use any regulating substances.

The polymerization may take place in the presence of fully or partially hydrolyzed polyvinylalcohol polymers (fully or partially hydrolyzed polyvinyl acetate) or hydrolyzed polyvinylalcohol/ethylene copolymers. When the latter are used, these are preferably protective colloids, with an ethylene content of from 1 to 15 mol %, with a degree of hydrolysis of the vinyl acetate units of 80 mol % to about 95 mol %, and with a Hoppler viscosity, in 4% strength aqueous solution, of from 2 to 30 mPas (Hoppler method at 2020 C., DIN 53015). In preferred embodiments, the Hoppler viscosity is from 3 to 25 mPas, and the degree of hydrolysis is from 85 to 90 mol %. The ethylene content is preferably from 1 to 5 mol %. The protective colloid content in dispersions and powders is in each case from 3 to 30% by weight, preferably from 5 to 20% by weight, based in each case on the base polymer. The protective colloids used are generally water-soluble. Lesser amounts of protective colloid are generally necessary when the addition polymer is not isolated, and is used in the process of the invention as an aqueous dispersion, as produced.

The protective colloids may be prepared by known processes for polyvinyl alcohol preparation. The polymerization process is preferably carried out in organic solvents at an elevated temperature, using peroxides as a polymerization initiator. Solvents used are preferably alcohols such as methanol or propanol. The ethylene content of the polymer may be controlled by means of the ethylene pressure. The resultant vinyl acetate-ethylene copolymer is preferably not isolated, but directly subjected to hydrolysis. The hydrolysis may take place by known processes, for example by using methanolic NaOH catalysis. After the hydrolysis, the solvent is replaced by water through work-up by distillation. The protective colloid is preferably not isolated but used directly in the form of an aqueous solution for the polymerization process.

Suitable emulsifiers include anionic, cationic, and non-ionic emulsifiers, for example anionic surfactants such as alkyl sulfates whose chain length is from 8 to 18 carbon atoms, or alkyl or alkyl aryl ether sulfates having from 8 to 18 carbon atoms in the hydrophobic radical and up to 40 ethylene or propylene oxide units, alkyl- or alkylarylsulfonates having from 8 to 18 carbon atoms, esters and half esters of sulfosuccinic acid with monohydric alcohols or with alkylphenols, or non-ionic surfactants such as alkyl polyglycol ethers or alkylarylpolyglycol ethers having from 8 to 40 ethylene oxide units. All of the monomers may form an initial charge, or all of the monomers may form a feed, or portions of the monomers may form an initial charge and the remainder may form a feed after the polymerization has been initiated. The procedure is preferably that from 50 to 100% by weight, based on the total weight of the monomers, form an initial charge and the remainder forms a feed. The feeds may be separate (spatially and chronologically), or all or some of the components to be fed may be fed after preemulsification.

All or a portion of the auxiliary monomers may likewise form an initial charge or form a feed, depending on their chemical nature. In the case of vinyl acetate polymerization processes, the auxiliary monomers may form a feed or may form an initial charge, depending on their copolymerization parameters. For example, acrylic acid derivatives may form a feed, whereas vinyl sulfonate may form an initial charge.

Monomer conversion is controlled by the addition of initiator. It is preferable for all of the initiators to form a feed.

Once the polymerization process has ended, post-polymerization may be carried out using known methods to remove residual monomer, one example of a suitable method being post-polymerization initiated by a redox catalyst. Volatile residual monomers may also be removed by distillation, preferably at subatmospheric pressure, and, where appropriate, by passing inert entraining gases, such as air, nitrogen, or water vapor, through or over the material.

Organopolysiloxanes bearing at least two ethylenically unsaturated groups (B) are well known, are commercially available, and preferably correspond to the formula (I):

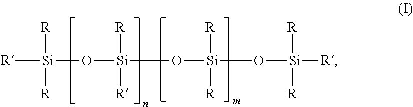

in which

R is a monovalent, SiC-bonded, optionally substituted C₁₋₁₈ hydrocarbon radical free of aliphatic carbon-carbon double bonds,

R′ is a monovalent, SiC-bonded, optionally substituted C₁₋₁₈ hydrocarbon radical containing at least one aliphatic carbon-carbon double bond, or R

m is an integer from 40 to 1000,

n is an integer from 0 to 10 and

m+n is an integer from 40 to 1000,

with the provision that the organopolysiloxane contains at least two R′ which are not R.

The organopolysiloxanes (B) bearing aliphatically unsaturated hydrocarbon groups may also be branched. Examples of branched organopolysiloxanes are those of the general formula

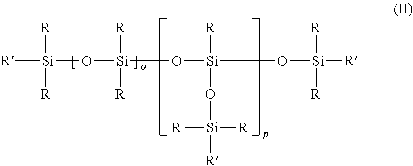

where R and R′ are as defined above,
o is 41 to 1000, preferably 80 to 500, more preferably 100 to 200, and
p is 1 to 6, more preferably 2 to 4, and at least two R′ are not R. Branched organopolysiloxanes having “p” units which are themselves polydiorganosiloxy groups are also quite useful. Many such branched organopolysiloxanes may have 2-6, preferably 3 or 4 polydiorganosiloxane groups of comparable size, e.g. in a star or comb-type arrangement. Such organopolysiloxanes may thus have the formula (IIa)

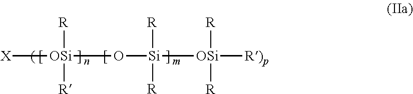

where m, n, and p have the meanings given above, and X is silicon, or an organopolysiloxane, organic polymer, or other organic radical having a valence of p.

For the purposes of this invention formulae (II) and (IIa) should be understood such that n units, m units, o units, and p units may be distributed in any way in the organopolysiloxane molecule, for example blockwise or randomly.

Examples of radicals R are alkyl radicals such as the methyl, ethyl, n-propyl, isopropyl, 1-n-butyl, 2-n-butyl, isobutyl, tert-butyl, n-pentyl, isopentyl, neopentyl, and tert-pentyl radicals, hexyl radicals such as the n-hexyl radical, heptyl radicals such as the n-heptyl radical, octyl radicals such as the n-octyl radical and isooctyl radicals such as the 2,2,4-trimethylpentyl radical, nonyl radicals such as the n-nonyl radical, decyl radicals such as the n-decyl radical, dodecyl radicals such as the n-dodecyl radical, and octadecyl radicals such as the n-octadecyl radical; cycloalkyl radicals such as the cyclopentyl, cyclohexyl, cycloheptyl and methylcyclohexyl radicals; aryl radicals such as the phenyl, naphthyl, anthryl and phenanthryl radicals; alkaryl radicals, such as the o-, m- and p-tolyl radicals, xylyl radicals, and ethylphenyl radicals; and aralkyl radicals such as the benzyl radical, and the α- and the β-phenylethyl radicals.

Examples of substituted radicals R are haloalkyl radicals such as the 3,3,3-trifluoro-n-propyl radical, the 2,2,2,2′,2′,2′-hexafluoroisopropyl radical, and the heptafluoroisopropyl radical, and haloaryl radicals such as the o-, m- and p-chlorophenyl radicals.

Preferably the radical R is a monovalent hydrocarbon radical having 1 to 6 carbon atoms, the methyl radical being particularly preferred. Examples of radicals R′ are alkenyl radicals such as the vinyl, 5-hexenyl, cyclohexenyl, 1-propenyl, allyl, 3-butenyl and 4-pentenyl radicals. Preferably the radical R′ comprises alkenyl radicals, the vinyl radical being particularly preferred.

The viscosity of the organopolysiloxanes (B) is not critical, and may, for example range from 10 mPa·s or lower to 1·10⁶ mPas or higher, since the organopolysiloxanes are present in emulsified form. High viscosity organopolysiloxanes may, however, prove more difficult to emulsify. The organopolysiloxanes (B) preferably possess an average viscosity of 100 to 50,000 mPa·s at 25° C., more preferably 200 to 40,000 mPa·s at 25° C.

The organopolysiloxanes (B) of the invention may be prepared by customary methods, for example, by of H-siloxane equilibration with the corresponding silanes. Examples of organopolysiloxanes (B) of the invention are organopolysiloxanes containing vinyl groups, of the formula

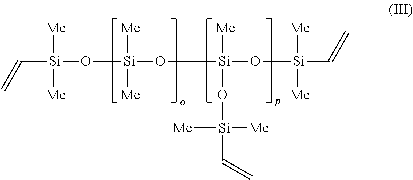

where Me is a methyl radical and o and p are as defined above.

In similar fashion, the crosslinker (C) can take varied forms, and Si—H functional crosslinkers are widely available. The Si—H functional crosslinkers are preferably linear, cyclic or branched organopolysiloxanes comprising units of the formula III

$${R}_{e}^{2} {H}_{f} {SiO}_{\frac{4 - e - f}{2}} \qquad ( III )$$

where

R² is a monovalent, SiC-bonded, unsubstituted or substituted (“optionally substituted”) hydrocarbon radical having 1 to 18 carbon atoms which is free from aliphatic carbon-carbon double bonds,

e is 0, 1, 2 or 3,

f is 0, 1 or 2,

and the sum of e+f is 0, 1, 2 or 3,

with the proviso that on average there are at least 2 Si-bonded hydrogen atoms. Examples of hydrocarbon radicals R² are the same as for hydrocarbon radicals R. The organosilicon compounds (C) preferably contain at least 3 Si-bonded hydrogen atoms.

Organopolysiloxanes which are more preferably used as organosilicon compounds (C) are those of the general formula

HₕR²₃₋ₕSiO(SiR²₂O)_{q}(SiR²HO)ᵣSiR²₃₋ₕHₕ (IV)

where R² is as defined above,

h is 0, 1 or 2,

q is 0 or an integer from 1 to 1500, and

r is 0 or an integer from 1 to 200,

with the proviso that there are on average at least 2 Si-bonded hydrogen atoms, and preferably 3 or more Si-bonded hydrogen atoms. For the purposes of this invention formula IV is to be understood such that q units —(SiR²₂O)— and r units —(SiR²HO)— may be distributed in any way in the organopolysiloxane molecule.

Examples of such organopolysiloxanes are, in particular, copolymers of dimethylhydrosiloxane, methylhydrosiloxane, dimethylsiloxane, and trimethylsiloxane units; copolymers of trimethylsiloxane, dimethylhydrosiloxane, and methylhydrosiloxane units; copolymers of trimethylsiloxane, dimethylsiloxane, and methylhydrosiloxane units; copolymers of methylhydrosiloxane and trimethylsiloxane units; copolymers of methylhydrosiloxane, diphenylsiloxane, and trimethylsiloxane units; copolymers of methylhydrosiloxane, dimethylhydrosiloxane, and diphenylsiloxane units; copolymers of methylhydrosiloxane, phenylmethylsiloxane, trimethylsiloxane and/or dimethylhydrosiloxane units; copolymers of methylhydrosiloxane, dimethylsiloxane, diphenylsiloxane, trimethylsiloxane and/or dimethylhydrosiloxane units; and copolymers of dimethylhydrosiloxane, trimethylsiloxane, phenylhydrosiloxane, dimethylsiloxane and/or phenylmethylsiloxane units.

The organopolysiloxanes (C) preferably have an average viscosity of 10 to 1000 mPa·s at 25° C., and are preferably used in amounts of 0.5 to 8.0, more preferably 1.0 to 5.0 gram atoms of Si-bonded hydrogen per mole of hydrocarbon radical R′ having a terminal aliphatic carbon-carbon double bond in the organopolysiloxane (B). Amounts as high or higher than 20 gram atoms of Si-bonded hydrogen per mole of unsaturated hydrocarbon groups can also be used, but are not preferred.

The crosslinking catalyst (D) can be any catalyst useful for addition crosslinking through a hydrosilylation reaction. Preferred catalysts are metals, and metal compounds and/or complexes, where the metal is a metal from the platinum group. Examples of such catalysts are metallic and finely divided platinum, which may be on supports such as silica, alumina or activated carbon, compounds or complexes of platinum such as platinum halides, e.g., PtCl₄, H₂PtCl₆.6H₂O, Na₂PtCl₄.4H₂O, platinum-olefin complexes, platinum-alcohol complexes, platinum-alkoxide complexes, platinum-ether complexes, platinum-aldehyde complexes, platinum-ketone complexes, including reaction products of H₂PtCl₆.6H₂O and cyclohexanone, platinum-vinylsiloxane complexes, such as platinum-1,3-divinyl-1,1,3,3-tetramethyldisiloxane complexes with or without detectable inorganically bonded halogen, bis(gamma-picoline)platinum dichloride, trimethylenedipyridineplatinum dichloride, dicyclopentadieneplatinum dichloride, dimethyl sulfoxide-ethyleneplatinum(II) dichloride, cyclooctadieneplatinum dichloride, norbornadieneplatinum dichloride, gamma-picolineplatinum dichloride, cyclopentadieneplatinum dichloride, and reaction products of platinum tetrachloride with olefin and primary amine or secondary amine or primary and secondary amine, such as the reaction product of platinum tetrachloride in solution in 1-octene with sec-butylamine, or ammonium-platinum complexes. The platinum catalysts may be thermally activatable, or photoactivatable.

The catalysts (D) are preferably used in amounts of 10 to 1000 ppm by weight (parts by weight per million parts by weight), more preferably 50 to 200 ppm by weight, calculated in each case as elemental platinum metal and based on the total weight of the organosilicon compounds (A) and (B).

The crosslinkable compositions may further comprise agents which retard the addition of Si-bonded hydrogen to aliphatic multiple bond at room temperature, commonly known as inhibitors (E). As inhibitors (E) it is possible, in the crosslinkable silicone coating compositions, to use any inhibitor which achieves the desired purpose. Examples of inhibitors (E) are 1,3-divinyl-1,1,3,3-tetramethyldisiloxane, benzotriazole, dialkylformamides, alkylthioureas, methyl ethyl ketoxime, organic or organosilicon compounds having a boiling point of at least 25° C. at 1012 mbar (abs.) and at least one aliphatic triple bond, such as 1-ethynylcyclohexan-1-ol, 2-methyl-3-butyn-2-ol, 3-methyl-1-pentyn-3-ol, 2,5-dimethyl-3-hexyne-2,5-diol, and 3,5-dimethyl-1-hexyn-3-ol, 3,7-dimethyloct-1-yn-6-en-3-ol, a mixture of diallyl maleate and vinyl acetate, maleic monoesters, and inhibitors such as the compound of the formula

HC≡C—C(CH₃)(OH)—CH₂—CH₂—CH═C(CH₃)₂,

available commercially under the trade name “Dehydrolinalool” from BASF SE.

Where inhibitor (E) is included, it is preferably used in amounts of 0.01% to 10% by weight, more preferably 0.01% to 3% by weight, based on the total weight of the organosilicon compounds (B) and (C). Mixtures of inhibitors may also be used.

Examples of further constituents which may be used in the release coating compositions are organic solvents, dyes, and pigments. These examples are illustrative and non-limiting, and other constituents may be used if desired. Inorganic fillers of silica, alumina, titania, and other inorganic compounds may also be present, but are not preferred.

The compositions are preferably free of controlled release additives. Examples of such additives are the CRA® controlled release additives from Wacker Chemie AG, Munich, Germany, such as CRA® 17 and CRA® 42. Controlled release additives for use in curable organopolysiloxane compositions are silicone resins. As is well known, silicone resins are highly crosslinked, network-like polymers, generally solid, having a high proportion of branching siloxy units, i.e. T units RSiO_{3/2} and Q units SiO_{4/2}.

Examples of controlled release agents from which the compositions of the invention are preferably free, are silicone resins comprising units of the formula

R³R²₂SiO_{1/2} and SiO₂,

commonly known as MQ resins, where R³ is a hydrogen atom, a hydrocarbon radical R², such as the methyl radical, or an alkenyl radical R′, such as the vinyl radical, and the units of the formula R³R²₂SiO_{1/2} may be identical or different. The ratio of units of the formula R³R²₂SiO_{1/2} to units of the formula SiO₂ is preferably 0.6 to 2. It would not depart from the spirit of the invention to add a most minor amount of a controlled release additive, for example less than 10% by weight relative to the sum of the weights of (B) and (C), preferably less than 5%, and most preferably less than 2%. The release coatings are preferably essentially free of controlled release additives, e.g. any controlled release additive present does not increase release force at 15 mm/min by more than 5% relative to a release coating not containing any controlled release additive.

Examples of organic solvents include petroleum spirits, e.g., alkane mixtures having a boiling range of 70° C. to 180° C., n-heptane, benzene, toluene and xylene(s), halogenated alkanes having 1 to 6 carbon atoms such as methylene chloride, trichloroethylene, and perchloroethylene, ethers, such as di-n-butyl ether, esters such as ethyl acetate, and ketones, such as methyl ethyl ketone and cyclohexanone. Where organic solvents are included they are preferably used in amounts of 5% to 50% by weight, more preferably 5% to 30% by weight, based on the total weight of the organosilicon compounds (A) and (B). Organic solvents are preferably absent, or are present in amounts of less than 20 weight percent relative to the total weight of the aqueous coating composition, preferably, with increasing order of preference, less than 15%, 10%, 5%, and 2% by weight.

The amount of addition curable silicone components (B) and (C) is with increasing preference, at least 2, 3, 4, or 5 weight percent, and at most 10, 15, 20, 25, 30, 35, 40, 45, or 50 weight percent, these weight percentages based on the total weights of (A), (B), and (C), expressed as solids. The consolidation liners exhibit a high parting force from cured composite structures. When tested by conventional methods, such as FINAT test methods 3 at a release speed of 30 mm/min, the consolidation liners preferably exhibit a release force greater than 325 g/25 mm, more preferably >350 g/25 mm, yet more preferably >450 g/25 mm, and most preferably >500 g/25 mm.

The compositions may include any ingredient or combination of ingredients listed as optional, i.e. which are not required ingredients, or may be free of such ingredients.

### EXAMPLES

### Example 1

Emulsions are prepared by admixing an aqueous vinyl addition polymer emulsion, ethylenically unsaturated organopolysiloxane, and Si—H crosslinking agent, as follows. The polyvinyl alcohol-stabilized ethylene/vinyl acetate copolymer emulsion is available from Wacker Chemie AG as VINNAPAS® 315, containing about 55% polymer, having a predominant particle size of 1.2-1.8 μm, and a viscosity of 1800-2700 mPas. The copolymer has a glass transition temperature of about 17° C.

The silicone components are DEHESIVE® EM 480, available from Wacker Chemie AG, an aqueous, linear vinyl polymer emulsion with about 50% solids also containing a platinum catalyst, and Wacker® crosslinker V72, an Si—H functional organopolysiloxane crosslinker containing about 30 Si—H bonded hydrogen atoms per molecule on average. These are mixed in the final emulsion according to the manufactures' recommendation, about 100 parts by weight of DEHESIVE EM 480 to about 8 parts by weight of crosslinker V72.

Preferably, addition polymer emulsion is first blended with the alkenyl-functional silicone to form a uniform dispersion, and then the crosslinker is added and blended to uniformity. The catalyst is usually added last, which is highly preferred, though in practice, the emulsions are very forgiving, and thus any addition order is satisfactory.

Following blending the emulsions, the emulsions are diluted with water, preferably with DI water, to a solids content of 10%, and rod-coated onto supercalendered kraft paper using a #8 Meyer rod. The coated paper is dried and cured at 160° C. for 20 seconds.

Parting force testing is initially performed on TESA test tape 7475 made with acrylic adhesive. Parting force is measured by FINAT test methods 3 and 4. The results are presented in Table 1 below, where percent silicone refers to the percent silicone solids relative to total solids. “CRA® EM 456” is an addition curable coating containing a silicone resin to increase the parting force, and is a comparative example.

TABLE 1

| Specimen | Parting Force, 30 mm/min | Parting Force, 15 m/min |
|---|---|---|
| CRA ® EM 456 | 302 g/25 mm | 73 g/25 mm |
| 10% silicone | 575 g/25 mm | 182 g/25 mm |
| 13% silicone | 451 g/25 mm | 114 g/25 mm |
| 17% silicone | 350 g/25 mm | 51 g/25 mm |
| 22% silicone | 287 g/25 mm | 51 g/25 mm |

The results indicate that the inventive parting coating can provide higher parting force than that possible using a controlled release additive.

### Example 2

Aqueous emulsions prepared in the same manner as in Example 1 are coated and cured onto the same paper to form consolidation liners. These coated papers are contacted with a filmic hot melt adhesive tape, TESA 4154, and tested under the same conditions as in Example 1. The results are presented in Table 2.

TABLE 2

| Specimen | Parting Force, 30 mm/min | Parting Force, 15 m/min |
|---|---|---|
| 10% silicone | 79 g/25 mm | 357 g/25 mm |
| 13% silicone | 51 g/25 mm | 222 g/25 mm |
| 17% silicone | 20 g/25 mm | 121 g/25 mm |
| 22% silicone | 12 g/25 mm | 99 g/25 mm |
| 30% silicone | 4.2 g/25 mm | 38 g/25 mm |
| 50% silicone | 3.6 g/25 mm | 22 g/25 mm |

The results in Table 2 illustrate that a wide range of parting force is made possible by the inventive compositions.

### Example 3

A 10 ply unidirectional planar laminate having dimensions of 20 cm×40 cm is prepared by laying up 10 plies of TORAYCA® carbon fiber prepreg FL66766-37E, containing unidirectional carbon fibers and 40% by weight of B-staged epoxy resin. The first ply is laid onto a consolidation liner as disclosed herein, which also is placed on top of the 10 ply uncured lay-up. The lay-up is then vacuum bagged, placed between two steel platens, and heated to 177° C. for two hours to cure. Following cure, the consolidation liners are still adhered to the cured composite. Removing the consolidation liners reveals a smooth composite surface.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. In a process for preparing a cured, multi-layer composite structure by laying up a plurality of polymer resin-containing, fiber reinforced prepregs to form an uncured multi-layer composite, and consolidating the uncured composite at elevated temperature, the improvement comprising employing a consolidation liner on at least one side of the composite during consolidation, wherein the consolidation liner has a surface coating prepared by coating a consolidation liner substrate with an aqueous emulsion comprising (A) a vinyl addition polymer, (B) an organopolysiloxane polymer bearing at least two ethylenically unsaturated groups, (C) an organosilicon crosslinker bearing at least three silicon bonded hydrogen atoms, and (D) a hydrosilylation catalyst, wherein components (B) and (C) are present in an amount of from about 5% by weight to about 50% by weight relative to the sum of (A), (B), and (C).

2. The process of claim 1, wherein the vinyl addition polymer (A) is an ethylene/vinylacetate copolymer.

3. The process of claim 1, wherein the surface coating is essentially free of controlled release additives.

4. The process of claim 1, wherein the surface coating contains less than 5 parts controlled release additive per 100 parts of (B) and (C).

5. The process of claim 1, wherein said consolidation liner is also adhered to the resin-containing fiber reinforced prepregs prior to laying up these prepregs.

6. The process of claim 1, wherein components (B) and (C) are present in an amount of from 5 to about 30 weight percent relative to the sum of (A), (B), and (C).

7. The process of claim 1, wherein components (B) and (C) are present in an amount of from 5 to about 20 weight percent relative to the sum of (A), (B), and (C).

8. The process of claim 1, wherein components (B) and (C) are present in an amount of from 5 to less than 20 weight percent relative to the sum of (A), (B), and (C).

9. The process of claim 1, wherein the aqueous emulsion has a solids content of from 2 to 50 weight percent, based on the total weight of the emulsion.

10. The process of claim 1, wherein the aqueous emulsion has a solids content of from 3 to 30 weight percent, based on the total weight of the emulsion.

11. The process of claim 1, wherein the aqueous emulsion has a solids content of from 4 to 15 weight percent, based on the total weight of the emulsion.

12. The process of claim 1, wherein at least one organopolysiloxane polymer B is selected from the group consisting of 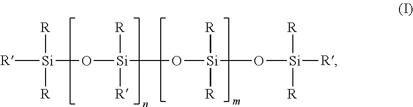
in which
R is a monovalent, SiC-bonded, optionally substituted C₁₋₁₈ hydrocarbon radical free of aliphatic carbon-carbon double bonds,
R′ is a monovalent, SiC-bonded, optionally substituted C₁₋₁₈ hydrocarbon radical containing at least one aliphatic carbon-carbon double bond, or R
m is an integer from 40 to 1000,
n is an integer from 0 to 10 and
m+n is an integer from 40 to 1000, 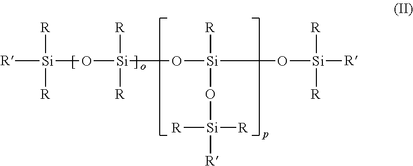
where R and R′ are as defined above,
o is 41 to 1000, and
p is 1 to 6, and at least two R′ are not R, and 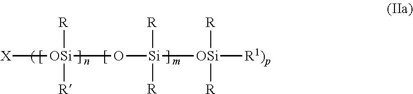
where m, n, and p have the meanings given above, and X is silicon, an organopolysiloxane, organic polymer, or organic radical having a valence of p.

13. The process of claim 12, wherein at least one organopolysiloxane (B) has the formula (I).

14. The process of claim 1, wherein at least one crosslinker (C) has the formula III:
$${R}_{e}^{2} {H}_{f} {SiO}_{\frac{4 - e - f}{2}} \qquad ( III )$$
where
R² is a monovalent, SiC-bonded, unsubstituted or substituted (“optionally substituted”) hydrocarbon radical having 1 to 18 carbon atoms which is free from aliphatic carbon-carbon double bonds,
e is 0, 1, 2 or 3,
f is 0, 1 or 2,
and the sum of e+f is 0, 1, 2 or 3,
with the proviso that on average there are at least 2 Si-bonded hydrogen atoms.

15. The process of claim 12, wherein at least one crosslinker (C) has the formula III:
$${R}_{e}^{2} {H}_{f} {SiO}_{\frac{4 - e - f}{2}} \qquad ( III )$$
where
R² is a monovalent, SiC-bonded, unsubstituted or substituted (“optionally substituted”) hydrocarbon radical having 1 to 18 carbon atoms which is free from aliphatic carbon-carbon double bonds,
e is 0, 1, 2 or 3,
f is 0, 1 or 2,
and the sum of e+f is 0, 1, 2 or 3,
with the proviso that on average there are at least 2 Si-bonded hydrogen atoms.

16. The process of claim 1, wherein the consolidation liner substrate comprises paper.

17. The process of claim 1, wherein the consolidation liner exhibits a parting force of 325 g/25 mm when tested at 300 mm/min TESA 7475 tape according to FINAT test method 3.

18. The process of claim 1, wherein the consolidation liner exhibits a parting force of 450 g/25 mm when tested at 300 mm/min TESA 7475 tape according to FINAT test method 3.
